(19) United States
(12) Patent Application Publication
(10) Pub. No.: US 2023/0182748 A1
(43) Pub. Date: Jun. 15, 2023

(54) TRANSMITTER ALTERATIONS BASED ON VIBRATION PATTERNS

(71) Applicant: Hewlett-Packard Development Company, L.P., Spring, TX (US)

(72) Inventors: Shih Huang Wu, Spring, TX (US); Ruei-Ting Miau, Spring, TX (US); Isaac Lagnado, Spring, TX (US)

(21) Appl. No.: 17/550,438

(22) Filed: Dec. 14, 2021

(51) Int. Cl. B60W 40/09; B60W 50/14

(52) U.S. Cl. CPC B60W 40/09; B60W 50/14; B60W 2050/146

(57) ABSTRACT

In some examples, the disclosure describes device that includes a motion sensor device, a transmitter device, and a processor to: determine a vibration pattern of the device based on data received from the motion sensor device, separate the vibration pattern into a user vibration pattern and external vibration pattern, and alter a power level of the transmitter based on the user vibration pattern.

### BACKGROUND

Computing devices are utilized to perform particular functions. In some examples, computing devices utilize battery power that is limited when the computing device is not connected to an electrical power source. In some examples, computing devices are mobile computing devices that are carriable or moveable from a first location to a second location. In some examples, a mobile computing device is positioned on a human user and the human user may be negatively affected by wireless transmissions during use.

### BRIEF DESCRIPTION OF THE DRAWINGS

FIG. 1 illustrates an example of a method for transmitter alterations based on vibration patterns.

FIG. 2 illustrates an example of a representation for transmitter alterations based on vibration patterns.

FIG. 3 illustrates an example of a method for transmitter alterations based on vibration patterns.

FIG. 4 illustrates an example of a computing device for transmitter alterations based on vibration patterns.

FIG. 5 illustrates an example of a memory resource for transmitter alterations based on vibration patterns.

FIG. 6 illustrates an example of a system for transmitter alterations based on vibration patterns.

### DETAILED DESCRIPTION

A user may utilize a computing device for various purposes, such as for business and/or recreational use. As used herein, the term computing device refers to an electronic device having a processor and a memory resource. Examples of computing devices include, for instance, a laptop computer, a notebook computer, a desktop computer, an all-in-one (AIO) computing device, and/or a mobile device (e.g., a smart phone, tablet, personal digital assistant, smart glasses, a wrist-worn device, etc.), among other types of computing devices.

Wireless computing devices are subject to Specific Absorption Rate (SAR) limits in many countries to ensure that human users are not exposed to unacceptable RF energy levels. SAR depends on a number of aspects including, for example, the position and orientation of the device relative to the user. For example, computing devices operate in a number of orientations, including, laptop mode, tablet mode, and tent mode, among other orientations. However, some usage modes correspond to a specific absorption rate (SAR) risk to the user of the mobile computing device. For example, a mobile laptop computing device operating in a laptop mode positioned on a user's lap can have a relatively higher SAR risk compared to the computing device operating in the laptop mode positioned on a table or other work surface.

As such, controlling radio frequency (RF) power can mitigate SAR risks. For example, RF power can be reduced in response to determining when the computing device is in contact with a user (e.g., positioned on a user's lap, etc.). In these examples, a motion sensor such as an accelerometer or gyro sensor is utilized to determine when vibrations are associated with the computing device. However, vibrations due to being positioned on a work surface while traveling in a vehicle can cause a false indication that the computing device is in contact with a user when the computing device is actually positioned on a work surface. In these examples, the vibration causes the computing device to lower the transmission power to a lower RF power to mitigate SAR risks to the user. This can lower the performance of the computing device even though the SAR risks to the user is not increased since the computing device is actually on a work surface.

The present disclosure relates to transmitter alterations based on vibration patterns to eliminate false positive indicators that the computing device is in contact with a human user. In this way, the computing device utilizes a greater RF power when the computing device is positioned on a work surface even when there are vibrations caused by a moving vehicle or exterior factors that are unrelated to being in physical contact with the human user. This may provide a relatively higher performance for the computing device when the device is positioned on the work surface.

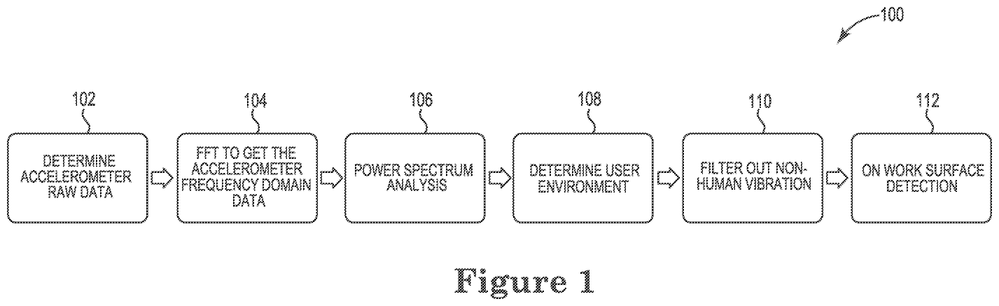

FIG. 1 illustrates an example of a method 100 for transmitter alterations based on vibration patterns. In some examples, the method 100 corresponds to instructions that are executed by a processor. For example, the method 100 corresponds to instructions that are stored on a non-transitory computer readable medium and executed by a processor to perform the corresponding functions of the method 100.

In some examples, the method 100 includes determining accelerometer raw data for a computing device at 102. In some examples, the accelerometer raw data includes measurements captured by an accelerometer or a plurality of accelerometers associated with a computing device. In some examples, the accelerometer raw data includes accelerometer data that is captured over a particular time period. In these examples, the accelerometer data is captured or measured utilizing a motion sensor such as an accelerometer or gyro sensor. As used herein, an accelerometer includes a sensor that detects changes in acceleration of a device and/or changes in vibrations. In some examples, the accelerometer data is utilized to generate vibration pattern for a computing device.

In some examples, the method 100 includes utilizing a Fast Fourier Transform (FFT) to generate the frequency domain data form the accelerometer data at 104. For example, a frequency domain is generated from data received by the accelerometer device utilizing FFT. In some examples, the frequency domain data illustrates a frequency of vibrations over a period of time. In this way, the frequency domain data illustrates a frequency of vibrations over a period of time. In some examples, the frequency of vibrations can correspond to particular vibration sources. For example, a frequency of vibrations below a threshold frequency may correspond to a human user moving the computing device on a lap or non-work surface. In other examples, a frequency of vibrations above a threshold may correspond to fast typing or external device other than the user interacting with the computing device.

In some examples, the method 100 includes performing a power spectrum analysis at 106. In some examples, performing the power spectrum analysis includes integrating the square of frequency domain data. That is, the square of the calculated frequency domain data from 104 can get the power spectrum density (PSD). In some examples, the power spectrum density indicates an energy level or power level of the vibrations. In some examples, the power level of the vibrations can indicate whether the vibrations are generated by a human user or a non-human user. For example, vibrations with a power level above a power threshold indicate that the vibrations were generated by a non-human user.

In some examples, the method 100 includes determining a user environment at 108. In some examples, determining the user environment includes generating vibration patterns for the computing device based on the frequency domain and power domain of the accelerometer data. In some examples, the vibration patterns of the computing device indicate how a user is utilizing the computing device. For example, the vibration patterns of the computing device can indicate when the computing device is positioned on a user's lap or is in contact with the user.

In some examples, the method 100 includes filtering out non-human vibrations from the vibration patterns at 110. As described herein, the vibration patterns can include vibration frequencies and/or vibration power levels that indicate the vibration is generated by a non-human environmental factor. For example, the vibration frequency and/or vibration power can indicate that the device is on a transportation vehicle when the vibration frequency is above a frequency threshold and/or when the vibration power level is above a power level threshold. In this way, the frequencies and/or power levels that are indicative of a non-human source are removed from the vibration pattern.

In some examples, the method 100 includes determining whether the computing device is on a work surface based on the vibration pattern with the removed non-human source patterns at 112. As described herein, removing the non-human source vibrations from the vibration pattern for the device allows the method 100 to determine when the computing device is positioned on a work surface of a moving vehicle or other environment with non-human vibrations acting on the computing device. In some examples, the vibration pattern with the removed non-human source vibrations are compared to human vibration patterns to determine when the computing device is in contact with a human user or when the computing device is positioned on a work surface. When the computing device is determined to be on a work surface, the power level of a transmitter can be adjusted to a high power. In contrast, the power level of the transmitter is adjusted to a lower level or adjusted for a SAR control mechanism to mitigate SAR risk to the human user when the vibration patterns and/or pattern components match the human user vibration patterns.

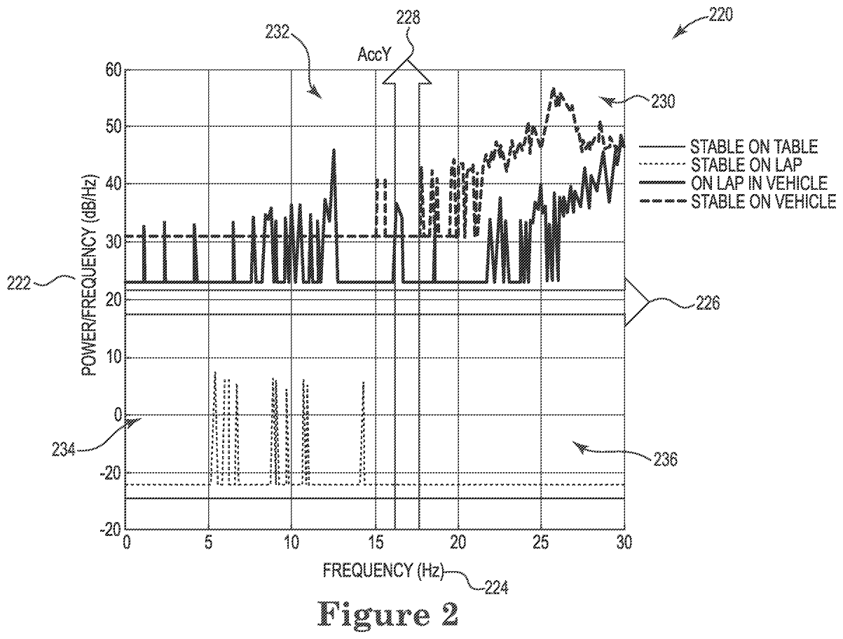

FIG. 2 illustrates an example of a representation 220 for transmitter alterations based on vibration patterns. In some examples, the representation 220 is a graphical representation where the x-axis 224 represents the frequency domain and the y-axis 222 represents the power domain. As described herein, the frequency domain and power domain are calculated from raw data of a motion sensor over a period of time.

In some examples, the representation 220 includes a power threshold 226 and a frequency threshold 228. The power threshold 226 and the frequency threshold 228 separates the representation 220 into a plurality of quadrants 230, 232, 234, 236. In some examples, the representation includes a first quadrant 230, a second quadrant 232, a third quadrant 234, and a fourth quadrant 236. In some examples, the first quadrant 230 includes vibration portions that are greater than the power threshold 226 and greater than the frequency threshold 228. In some examples, the first quadrant 230 corresponds to non-human source vibrations. For example, the vibrations within the first quadrant 230 can correspond to vibrations caused by vehicles (e.g., airplane, car, bus etc.). In this way, the vibration portions that are within the first quadrant 230 are removed from the vibrational patterns utilized to determine when a computing device is on a work surface or in contact with a user.

In some examples, the second quadrant 232 includes vibration portions that are greater than the power threshold 226 and less than the frequency threshold. In some examples, the frequency of the vibrations can indicate that a user is in contact with the computing device and the power level can indicate that the computing device is on a transportation vehicle. That is, the power level can be due to the computing device being on a transportation vehicle or within an environment that includes non-human sources of vibrations. In some examples, the vibration portion within the second quadrant 232 indicates that the computing device is on a transportation vehicle while also in contact with the human user (e.g., on a lap of the user, etc.) or that the computing device is not positioned on a work surface such as a table or tray. In these examples, the power level of the transmitter is altered in response to the vibration pattern being within the second quadrant 232.

In some examples, the third quadrant 234 includes vibration patterns that are less than the power threshold 226 and less than the frequency threshold 228. In some examples, the vibration portion of the vibration pattern that is within the third quadrant 234 indicates the computing device is not on a transportation vehicle or not altered by non-human vibration sources. In some examples, vibration patterns within the third quadrant 234 indicate that the computing device is in contact with a human user. In these examples, the vibration portion within the third quadrant 234 indicates the power level of the transmitter is to be lowered to mitigate the SAR risk to a human user.

In some examples, the fourth quadrant 236 includes vibration portions that are greater than the frequency threshold 228 and less than the power threshold 226. In some examples, the vibration portions within the fourth quadrant 236 indicate that a user is typing quickly or tapping an input at a relatively high rate. In some examples, the vibration portion within the fourth quadrant 236 do not correspond to the computing device being in contact with the human user. In these examples, the vibration pattern within the fourth quadrant 236 may indicate that the power level of the transmitter can be at a normal level or may be increased to a level without considering the SAR risk to the human user.

The representation 220 illustrates a visual representation of the frequency threshold 228 and power threshold 226 are utilized to analyze a plurality of vibration patterns associated with a computing device. In these examples, the vibration patterns within each of the four quadrants 230, 232, 234, 236 are utilized to determine vibrations caused by human users and vibration patterns caused by non-human users. In this way, a transmitter of the computing device is altered based on the vibration patterns associated with a human user.

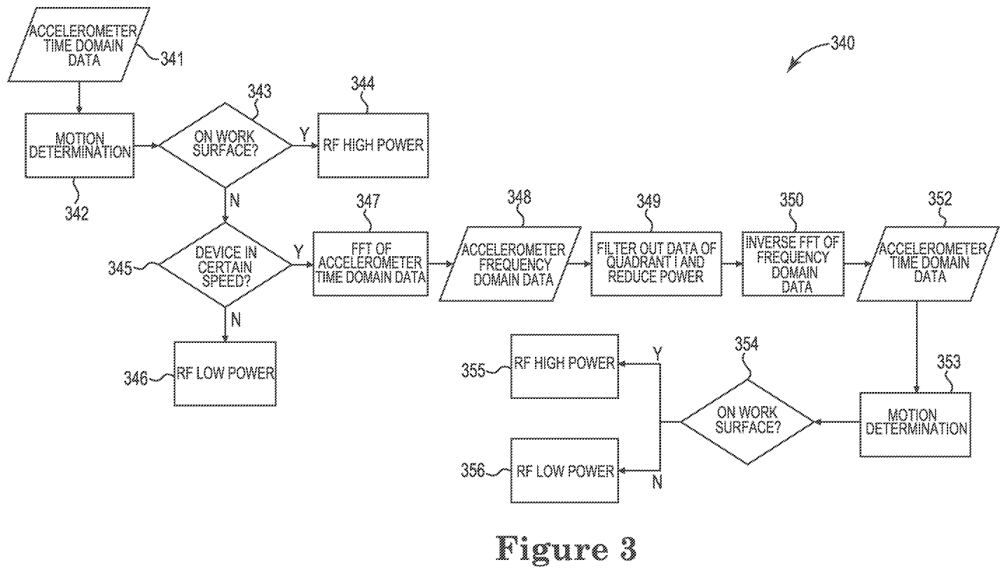

FIG. 3 illustrates an example of a method 340 for transmitter alterations based on vibration patterns. In some examples, the method 340 represents instructions that can be executed by a processor of a computing device. In some examples, the method 340 is utilized to determine when a computing device is positioned on a work surface such as a table or when the computing device is positioned on a lap of a user. As described herein, the power level of a wireless transmitter of the computing device is altered to lower a SAR risk to the human user when it is determined the computing device is in physical contact with the human user.

In some examples, the method 340 includes collecting accelerometer data at 341. In some examples, the computing device includes a motion sensor such as an accelerometer to collect the accelerometer data at 341. In some examples, the accelerometer data is accelerometer time domain data or motion data over a period of time. In some examples, the accelerometer data is utilized to perform a motion determination at 342. In some examples, the motion determination at 342 is utilized to determine when the accelerometer data indicates that the computing device is vibrating above a minimum vibration threshold.

As described herein, a minimum vibration threshold was utilized to indicate that the transmitter of the computing device should activate a SAR mechanism to lower the power level of the transmitter to mitigate or lower SAR risk to a user. However, the minimum vibration threshold can activate the SAR mechanism in response to non-human vibration patterns and lower performance of the computing device even when the computing device is being utilized on a table or tray.

In some examples, the method 340 determines when the computing device is on a table or tray at 343 in response to the motion determination at 342. In some examples, the method 340 allows the transmitter to operate using a high RF power level at 344 when the method 340 determines the computing device is on a table or tray. In other examples, the method 340 determines whether the computing device is moving at a particular velocity or speed at 345 when the method 340 determines the minimum vibration threshold of the motion determination at 342 has been exceeded. In some examples, the method 340 determines the computing device is on a lap of the user when the computing device is not moving at a particular velocity or speed. This can indicate that non-human vibrations are not a factor in exceeding the minimum vibration threshold and that the computing device is likely on the user's lap or in physical contact with the user. In these examples, the method alters the transmitter of the computing device to a RF low power or lower RF power to mitigate SAR risk to the user at 346.

In some examples, the method 340 determines that the computing device is exceeding a threshold velocity or speed at 345 and performs a FFT of the accelerometer time domain data to determine an accelerometer frequency domain data of the vibrations of the computing device over a period of time at 347. As described herein, the accelerometer time domain data can be represented as a graphical representation (e.g., representation 220 as referenced in FIG. 2, etc.). As described in FIG. 2, the representation can include quadrants that include portions of the vibration pattern to remove (e.g., quadrant 1, etc.). In these examples, the quadrants that include vibration pattern portions that exceed a frequency threshold, and a power threshold are removed from the representation at 349. For example, the data within quadrant 1 is filtered out or removed from the representation at 349.

In some examples, the method includes 350 taking the inverse FFT of the frequency domain data once the data within quadrant 1 is removed. The method then determines the accelerometer time domain data from the inverse FFT at 352. The method utilizes the accelerometer time domain data for a motion determination at 353. In some examples, the motion determination at 353 is the same or similar motion determination as the motion determination performed at 342. However, as described herein, the motion determination at 353 does not include vibration data or motion data within quadrant 1. For example, the motion determination at 353 does not include vibration patterns that exceed a frequency threshold and/or a power threshold, which can be from a non-human source.

The motion determination at 353 is utilized to determine whether the computing device is on a work surface (e.g., table, tray, etc.). The method 340 allows the transmitter of the computing device to operate at a high RF power at 355 when it is determined the computing device is on the work surface and lowers the RF power to a low RF power at 356 when it is determined the computing device is not on a work surface. In this way, the method 340 prevents non-human vibration patterns from altering the RF power of the transmitter.

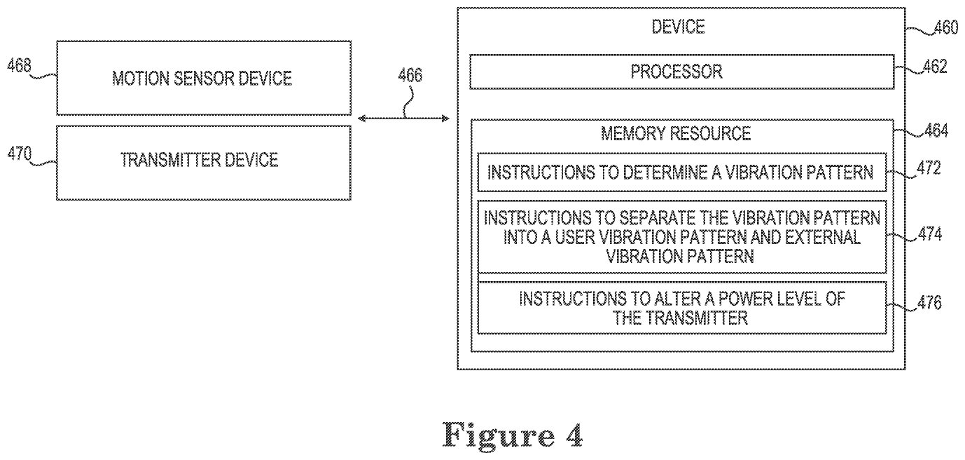

FIG. 4 illustrates an example of a device 460 for transmitter alterations based on vibration patterns. In some examples, the device 460 is a computing device that includes a processor 462 and a memory resource 464 to store instructions that are executed by the processor 462. In some examples, the device 460 includes a processor 462 and a memory resource 464 storing instructions 472, 474, 476, that can be executed by the processor 462 to perform particular functions. In some examples, the device 460 is communicatively coupled to a motion sensor device 468 and/or transmitter device 470 through a communication path 466. In some examples, the communication path 466 allows the device 460 to send and receive signals (e.g., communication signals, electrical signals, etc.) with the motion sensor device 468 and/or the transmitter device 470. In some examples, the device 460 is able to execute the methods described herein.

The device 460 includes instructions 472 stored by the memory resource 464 that is executed by the processor 462 to determine a vibration pattern of the device 460 based on data received from the motion sensor device 468. As described herein, a vibration pattern of the device 460 includes data that represents a vibration frequency level and vibration power level over a period of time. In this way, the vibration pattern is analyzed to identify human vibrations and non-human vibrations. In some examples, the device 460 includes instructions to determine when a velocity of the device 460 exceeds a threshold velocity. In some examples, a global positioning system (GPS) is utilized to determine when the device 460 meets or exceeds a threshold velocity.

In some examples, the device 460 includes instructions to generate frequency domain data and power spectrum density data based on the data received from the motion sensor device 468. In some examples, the frequency domain data and power spectrum density data are generated in responses to the velocity of the device 460 exceeding the threshold velocity. As described herein, the frequency domain data and power spectrum density data are generated utilizing FFT as described herein. In these examples, the device 460 includes instructions to separate the vibration pattern based on a comparison between the frequency domain data and the power spectrum density data.

The device 460 includes instructions 474 stored by the memory resource 464 that is executed by the processor 462 to separate the vibration pattern into a user vibration pattern and external vibration pattern. In these examples, the device 460 includes instructions to identify the external vibration pattern from a portion of the vibration pattern that exceed a frequency threshold and a power spectrum density threshold. As described herein, the user vibration patterns are identified based on a frequency level and/or power level of the vibration pattern or portion of the vibration pattern. In some examples, the user vibration pattern is associated with human user vibrations that are caused by a user physically interacting with the device. For example, a user vibration pattern includes a user placing the device 460 on the lap of the user and vibrations acting on the device 460 while on the lap of the user.

In some examples, the external vibration pattern includes vibration sources that are non-human sources of vibrations. For example, the external vibration pattern can be vibrations caused by a moving vehicle (e.g., airplane, bus, train, car, etc.). In this way, the non-human sources of vibrations may not indicate when the user is in physical contact with the device 460 and/or may not indicate when the user is more susceptible to SAR risk caused by the transmitter device 470. In these examples, the device 460 includes instructions to remove the external vibration pattern from the vibration pattern.

The device 460 includes instructions 476 stored by the memory resource 464 that is executed by the processor 462 to alter a power level of the transmitter device 470 based on the user vibration pattern. In some examples, the device 460 includes instructions to lower the power level of the transmitter device 470 below a threshold power level in response to the user vibration pattern being below a frequency threshold and a power spectrum density threshold.

As described herein, the external vibration patterns and/or non-human vibration patterns can be removed from the vibration pattern utilized to determine whether the device 460 is in physical contact with the human user. In this way, the power level of the transmitter device 470 is altered based on the user vibration pattern to determine when the device 460 is on a work surface or not in contact with a human user even when the device 460 is in a moving vehicle or experiencing external vibrations.

As described herein, the device 460 includes a processor 462 communicatively coupled to a memory resource 464 through a communication path. As used herein, the processor 462 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 472, 474, 476. In other examples, the device 460 includes instructions 472, 474, 476, stored on a machine-readable medium (e.g., memory resource 464, non-transitory computer-readable medium, etc.) and executable by a processor 462. In a specific example, the processor 462 utilizes a non-transitory computer-readable medium storing instructions 472, 474, 476, that, when executed, cause the processor 462 to perform corresponding functions.

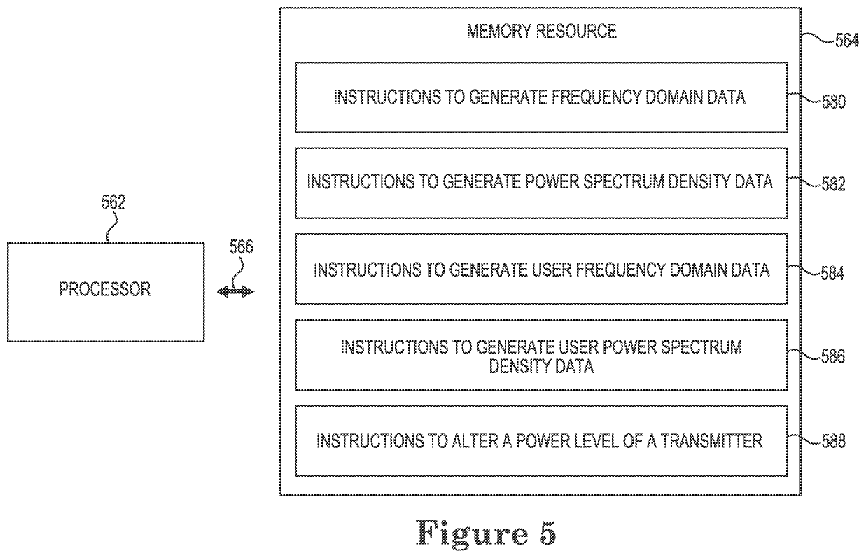

FIG. 5 illustrates an example of a memory resource 564 for transmitter alterations based on vibration patterns. In some examples, the memory resource 564 can be a part of a computing device or controller that can be communicatively coupled to a computing system. For example, the memory resource 564 can be part of a device 460 as referenced in FIG. 4. In some examples, the memory resource 564 can be communicatively coupled to a processor 562 that can execute instructions 580, 582, 584, 586, 588, stored on the memory resource 564. For example, the memory resource 564 can be communicatively coupled to the processor 562 through a communication path 566. In some examples, a communication path 566 can include a wired or wireless connection that can allow communication between devices and/or components within a single device.

The memory resource 564 may be electronic, magnetic, optical, or other physical storage device that stores executable instructions. Thus, a non-transitory machine-readable medium (MRM) (e.g., a memory resource 564) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., a memory resource 564) may be disposed within a controller and/or computing device. In this example, the executable instructions 580, 582, 584, 586, 588, can be “installed” on the device. Additionally, and/or alternatively, the non-transitory machine-readable medium (e.g., a memory resource) can be a portable, external, or remote storage medium, for example, that allows a computing system to download the instructions 580, 582, 584, 586, 588 from the portable/external/remote storage medium. In this situation, the executable instructions may be part of an “installation package”.

In some examples, the memory resource 564 includes instructions 580 to generate frequency domain data for the computing device based on motion data received from a motion sensor device. In some examples, the frequency domain data includes a vibration frequency of the computing device. As described herein, the frequency domain data can represent a frequency of vibrations of time. In some examples, the frequency domain data is compared to a frequency threshold. In some examples, the frequency threshold is between 15 hertz and 20 hertz. In some examples, a portion of the frequency domain data below the frequency threshold indicates that a human user may be interacting with the computing device by placing the computing device on a lap or in contact with the user during use. In other examples, the frequency domain data greater than the frequency threshold indicates that a user is typing or using the computing device at a relatively high rate. For example, the user may be typing at a relatively high rate or selecting an input at a relatively high rate.

In some examples, the memory resource 564 includes instructions to determine a frequency domain data range that corresponds to non-human user vibrations. The frequency domain data range that corresponds to non-human user vibrations can be utilized to remove a portion of the frequency data the corresponds to non-human user vibrations.

In some examples, the memory resource 564 includes instructions 582 to generate power spectrum density data for the computing device based on the frequency domain data. In some examples, the power spectrum density data is a power level of the vibration frequency of the computing device. In some examples, the memory resource 546 includes instructions to generate a power spectrum density domain from a square of the frequency domain. For example, the power spectrum density data is calculated by a square of the frequency domain data. In some examples, the power spectrum density data illustrates an energy level or power level of the vibrations applied to the computing device. In some examples, the power spectrum density data is compared to a power threshold. In some examples, the power level indicates that a non-human vibration source is acting on the computing device. In some examples, the power level of the vibrations can be above a power level threshold when a non-human vibration source is acting on the computing device.

In some examples, the memory resource 564 includes instructions to determine a power spectrum density data range that corresponds to non-human user vibrations. The power spectrum density data range that corresponds to non-human user vibrations can be utilized to remove a portion of the frequency data that corresponds to non-human vibrations.

In some examples, the memory resource 564 includes instructions 584 to remove a portion of the frequency domain data that exceeds a frequency threshold to generate user frequency domain data. As used herein the user frequency domain data includes vibration frequency data that is associated with a user. As described herein, the vibration frequency threshold is utilized to determine when the vibration frequency corresponds to the computing device being positioned on the user's lap compared to the computing device being positioned on a work surface.

In some examples, the frequency domain data that exceeds the frequency threshold includes vibration data that is caused by a non-human user and/or is vibration data that is not related to positioning the computing device on a lap of the user. In this way, the frequency domain data that is greater than the frequency threshold is removed before determining whether the vibration data indicates that the computing device is positioned on a work surface or on a user's lap.

In some examples, the memory resource 564 includes instructions 586 to remove a portion of the power spectrum density data that exceeds a power threshold to generate user power spectrum density data. As used herein, the user power spectrum density data includes vibration data associated with a user interacting with the computing device. As described herein, the portion of the power spectrum density data that exceeds the power threshold can indicate vibrations that are generated by non-human users. In some examples, the power spectrum density data is utilized to determine when the computing device is affected by non-human vibrations when the power density is greater than the power threshold and not affected by non-human vibrations when the power density is less than the power threshold.

In some examples, the memory resource 564 includes instructions 588 to alter a power level of a transmitter of the computing device based on the user frequency domain data and the user power spectrum density data. In some examples, the memory resource 564 includes instructions to activate a specific absorption rate (SAR) control mechanism in response to the user frequency domain data and the user power spectrum density data exceeding a vibration threshold. In these examples, the SAR control mechanism alters a power of the transmitter to lower radio frequency risks to a human user. As described herein, the power level of the transmitter is altered to a lower RF power level when the user frequency domain data and the user power spectrum density data indicate that the computing device is positioned on a user's lap or in contact with the user.

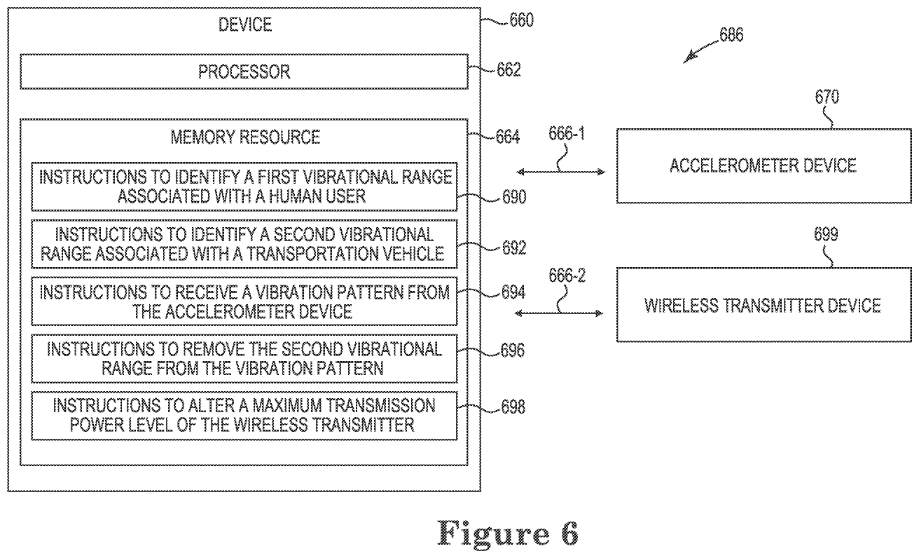

FIG. 6 illustrates an example of a system 686 for transmitter alterations based on vibration patterns. In some examples, the system 686 includes a device 660 that includes a processor 662 communicatively coupled to a memory resource 664. In some examples, the device 660 can include a computing device that includes a processor 662 and a memory resource 664 storing instructions 690, 692, 694, 696, 698, that are executed by the processor 662 to perform particular functions.

In some examples, the system 686 includes an accelerometer device 670 communicatively coupled to the device 660 through a communication path 666-1. In some examples, the accelerometer device 670 sends accelerometer data and/or motion data to the device 660. In some examples, the system 686 includes a wireless transmitter device 699 communicatively coupled to the device 660 through a communication path 666-2. In these examples, the wireless transmitter device 699 is altered by the device 660. In some examples, the wireless transmitter device 699 includes a high RF power mode and a low RF power mode. In these examples, the high RF power mode is utilized or activated when the device 660 is on a work surface and the low RF power mode is utilized or activated when the device 660 is on a lap or in physical contact with a human user. In these examples, the low RF power mode is a SAR control mechanism to mitigate SAR risk to the human user.

The device 660 includes instructions 690 stored by the memory resource 664 that can be executed by the processor 662 to identify a first vibrational range associated with a human user of the device 660. In some examples, the first vibrational range is below a first frequency threshold and a first power threshold. As described herein, the first vibrational range indicates the device 660 is positioned on a lap of the human user. As described herein, the first vibrational range is within a particular quadrant associated with vibrations generated by a human user. For example, the first vibrational range includes a frequency range that is below a frequency threshold and a power range below a power threshold.

The device 660 includes instructions 692 stored by the memory resource 664 that can be executed by the processor 662 to identify a second vibrational range associated with a transportation vehicle. In some examples, the second vibrational range is above a second frequency threshold and a second power threshold. In some examples, the second vibrational range is associated with vibrations generated by non-humans and/or particular transportation vehicles. In other examples, the second vibrational range includes a frequency range greater than a frequency threshold and a power range greater than a power threshold.

The device 660 includes instructions 694 stored by the memory resource 664 that can be executed by the processor 662 to receive a vibration pattern from the accelerometer device 670 wherein the vibration pattern includes a relationship between a vibration frequency and a vibration power of the device 660 over a period of time. In some examples, the vibration pattern from the accelerometer device 670 includes the frequency data and corresponding power data over a period of time. In some examples, the vibration pattern is represented in a graphical representation as illustrated in FIG. 2 to identify portions of the vibration pattern within corresponding quadrants. As described herein, portions of vibration patterns within particular quadrants are removed to filter out vibration portions associated with non-human sources and/or transportation vehicles.

The device 660 includes instructions 696 stored by the memory resource 664 that can be executed by the processor 662 to remove the second vibrational range from the vibration pattern of the device 660. As described herein, the first vibrational range corresponds to human users and the second vibrational range corresponds to transportation vehicles.

The device 660 includes instructions 698 stored by the memory resource 664 that can be executed by the processor 662 to alter a maximum transmission power level of the wireless transmitter device 699 in response to the vibration pattern with the removed second vibrational range matching the first vibrational range. In some examples, the maximum transmission power level corresponds to a mode of the wireless transmitter device 699. The maximum transmission power level includes a high RF power level and a low RF power level. In some examples, the high RF power level corresponds to higher performance and a higher SAR risk to a human user while the low RF power level corresponds to a lower performance and a lower SAR risk to the human user. In this way, the maximum transmission power level is adjusted based on whether the device 660 is in physical contact with the user or whether the device 660 is on a work surface.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A device, comprising:
a motion sensor device.
a transmitter device; and
a processor to:
determine a vibration pattern of the device based on data received from the motion sensor device;
separate the vibration pattern into a user vibration pattern and external vibration pattern; and
alter a power level of the transmitter device based on the user vibration pattern.

2. The device of claim 1, wherein the processor is to generate frequency domain data and power spectrum density data based on the data received from the motion sensor device.

3. The device of claim 2, wherein the processor is to separate the vibration pattern based on a comparison between the frequency domain data and the power spectrum density data.

4. The device of claim 1, wherein the processor is to identify the external vibration pattern from a portion of the vibration pattern that exceed a frequency threshold and a power spectrum density threshold.

5. The device of claim 1, wherein the processor is to lower the power level below a threshold power level in response to the user vibration pattern being below a frequency threshold and a power spectrum density threshold.

6. The device of claim 1, wherein the processor is to remove the external vibration pattern from the vibration pattern.

7. The device of claim 1, wherein the processor is to determine when a velocity of the device exceeds a threshold velocity based on the data received from the motion sensor device.

8. A non-transitory memory resource storing machine-readable instructions stored thereon that, when executed, cause a processor of a computing device to:
generate frequency domain data for the computing device based on motion data received from a motion sensor device;
generate power spectrum density data for the computing device based on the frequency domain data;
remove a portion of the frequency domain data that exceeds a frequency threshold to generate user frequency domain data;
remove a portion of the power spectrum density data that exceeds a power threshold to generate user power spectrum density data; and
alter a power level of a transmitter of the computing device based on the user frequency domain data and the user power spectrum density data.

9. The memory resource of claim 8, wherein the processor is to determine a power spectrum density data range that corresponds to non-human user vibrations.

10. The memory resource of claim 8, wherein the processor is to determine a frequency domain data range that corresponds to non-human user vibrations.

11. The memory resource of claim 8, wherein the frequency domain data includes a vibration frequency of the computing device.

12. The memory resource of claim 11, wherein the power spectrum density data is a power level of the vibration frequency of the computing device.

13. The memory resource of claim 8, wherein the processor is to activate a specific absorption rate (SAR) control mechanism in response to the user frequency domain data and the user power spectrum density data exceeding a vibration threshold.

14. The memory resource of claim 13, wherein the SAR control mechanism alters a power of the transmitter to lower radio frequency risks to a human user.

15. A device, comprising:
an accelerometer device;
a wireless transmitter device; and
a processor to:
identify a first vibrational range associated with a human user of the device;
identify a second vibrational range associated with a transportation vehicle;
receive a vibration pattern from the accelerometer device wherein the vibration pattern includes a relationship between a vibration frequency and a vibration power of the device over a period of time;
remove the second vibrational range from the vibration pattern of the device; and
alter a maximum transmission power level of the wireless transmitter device in response to the vibration pattern with the removed second vibrational range matching the first vibrational range.

16. The device of claim 15, wherein the first vibrational range is below a first frequency threshold and a first power threshold.

17. The device of claim 16, wherein the second vibrational range is above a second frequency threshold and a second power threshold.

18. The device of claim 15, wherein the processor is to generate a frequency domain from data received by the accelerometer device utilizing Fast Fourier Transform (FFT).

19. The device of claim 18, wherein the processor is to generate a power spectrum density domain from a square of the frequency domain.

20. The device of claim 15, wherein the first vibrational range indicates the device is positioned on a lap of the human user.
